(19) United States
(12) Patent Application Publication
(10) Pub. No.: US 2015/0302335 A1
(43) Pub. Date: Oct. 22, 2015

(54) System and method for evaluating leadership abilities and identifying leadership talent among users and organizations in a social network

(71) Applicant: Richard Unda, Lindenhurst, IL (US)

(72) Inventor: Richard Unda, Lindenhurst, IL (US)

(21) Appl. No.: 14/254,890

(22) Filed: Apr. 16, 2014

(51) Int. Cl. G06Q 10/06

(52) U.S. Cl. CPC G06Q 10/06393

(57) ABSTRACT

A system and method for evaluating leadership abilities and identifying leadership talent among users and organizations in a social network, and to compare the leadership abilities of a user to the leadership abilities of other users or categories of users in a social network. The system includes: (1) a user account module configured to create a user profile, (2) a rater invite module configured to send requests for a single evaluation or multiple/subsequent evaluations from individuals that serve on the user's “leadership panel,” (3) a rater categorization module configured to categorize raters in relation to the user, (4) a user request module configured to allow a user to request to evaluate another user, (5) an evaluation module configured to submit ratings of leadership attributes and competencies received from raters or as an optional self-evaluation using a five-point rating scale, and (6) a computation module to capture and update ratings, compute an overall leadership score, assess leadership performance, and determine the “leadership zone” within which an individual falls based on their overall leadership score and number of ratings. Segmentation of users by defined zones allows for the identification of high performance leaders based on experiential input from individuals that have knowledge and observations of the leader and reflects the aggregated assessment of an individual's leadership qualities.

### CROSS-REFERENCE TO RELATED REFERENCES

1. US20040153351A1, Filed—Jan. 31, 2003, Published—Aug. 5, 2004, Anne Deering, Robert Dilts, Julian Russell. Method and system for assessing leadership skills.
2. US20130110732A1, Filed—Oct. 26, 2012, Published—May 2, 2013, Rahul Uppal. System and method for evaluating trustworthiness of users in a social network:
3. US20130166466A1, Filed—Dec. 26, 2012, Published—Jun. 27, 2013, Joan Sanger. Social networks and career management.
4. W02013119839A1, Filed—Feb. 7, 2013, Published—Aug. 15, 2013, Dominique Hermsdorff, Geoffrey Lee, Yuriy Mikhalevskiy, Marylene Delbourg-Delphis. Methods and apparatus for a social recruiting network.
5. US2004/0253571A1, Filed—Jun. 3, 2004, Published—Dec. 16, 2004, Pierre Jean Valayer, Clemientine Aude Valayer, Monique Valayer. Process and kit for the evaluation of leadership abilities.

### FIELD OF THE INVENTION

The present invention relates to evaluating and identifying leadership talent among users and organizations in a social network by invoking a system to evaluate and assess the leadership attributes and competencies of users and/or the general leadership of an organization in a social network. Furthermore, the invention relates to a method of assessment in a human resource management system, to hiring employees, and matching the core leadership values of employers to employees.

### BACKGROUND

The United States Army defines leadership as the process of influencing people by providing purpose, direction, and motivation to accomplish the mission and improve the organization. An ideal leader has strong intellect, physical presence, professional competence, moral character and serves as a role model. An ideal leader is also able and willing to act decisively, within the intent and purpose of superior leaders and in the best interest of the organization. Leaders recognize that organizations, built on mutual trust and confidence, successfully accomplish objectives and goals. The Hayes Group International states, “the most effective organizations are planning now for tomorrow's leaders—specifically by interviewing for future leader skill sets and coaching/training those who are in the leadership pipeline on the key leadership competencies [1].”

Along these lines, understanding perceptions and receiving feedback are key leadership principles. Leaders need to know how effective they are at influencing people and organizations. However, leaders often find it difficult to gain an understanding of their effectiveness. For example, business results do not necessarily translate into effective leadership, self-aware/self-assessment methods can prove difficult, and workplace environments frequently discourage open and honest feedback to leaders. Furthermore, it is well known that many feedback and evaluation systems are not working as intended. Frequent complaints include, they take too much time, have little value, aren't fair, create anti-collaborative incentives, produce anxiety and low morale [2]. Nevertheless, studies show that people who solicit feedback, especially recommendations for improvement, generally receive higher performance evaluations [3]. Douglas Stone states, “When you solicit feedback, you are sending a message about yourself—that you are open, confident, care about the views of others, and are eager to improve [4].” Additionally, organizations need a way of rapidly and effectively assessing leadership strengths and development needs, with a view to retaining the best talent, building leadership strengths, and assessing management fit in key positions.

Professional social media platforms can facilitate the exchange of information in a manner that promotes increased awareness and candor. This premise is supported by research on the current use of user-generated content (UGC) such as consumer ratings by individuals where data demonstrates that collective benefits will emerge from aggregated contributions [5]. Currently, professional social media platforms do not provide a method for users to present or exchange information that assists in validating their performance as a leader. In this regard, the advantage of UGC in evaluating leadership performance is the capacity to leverage the highly experiential aspects of an individual's knowledge and observations of a leader, making aggregated experiences available. Furthermore, aggregated UGC in sufficient quantities have proven valid and reliable. For example, consumer reviews have proven to be a stronger predictor of the trustworthiness of an online store than either store reputation or assurance seals [6]. Thus, organizations can leverage internal social media platforms to acquire information that will help assess leadership influence on the workplace environment and the overall success of a team or department. In a professional environment where leadership attributes and competencies are paramount, a method to present leadership evaluations that are received in a non-attributable format fills a significant and important information deficiency. Furthermore, the establishment of a network comprised of professionals with scores and ratings on their leadership attributes and competencies provides a potential pool of talented leaders with proven leadership skills.

### SUMMARY OF THE INVENTION

A system and method for identifying leadership talent among users and organizations in a social network by evaluating and assessing leadership abilities are provided herein. In one embodiment, the system to evaluate and assess the leadership abilities of a user in the social network includes: (1) a user account module configured to create a user profile, (2) a rater invite module configured to send requests for a single evaluation or multiple/subsequent evaluations from individuals that serve on the user's “leadership panel,” (3) a rater categorization module configured to categorize raters in relation to the user, (4) a user request module to allow a user to send an unsolicited request to evaluate another user, (5) an evaluation module configured to submit ratings of leadership attributes and competencies received from raters or as an optional self-evaluation using a five-point rating scale, and (6) a computation module to capture and update ratings, compute an overall leadership score, assess leadership performance, and determine the “leadership zone” within which an individual falls based on their overall leadership score and number of ratings. Segmentation of users by defined zones allows for the identification of high performance leaders based on experiential input from individuals that have knowledge and observations of the leader and reflects the aggregated assessment of an individual's leadership qualities.

In another embodiment, a method for evaluating and assessing the leadership abilities of a user in a social network system is provided, the method comprising the steps of: (1) receiving a request to establish a user profile, (2) sending invitations to request evaluations from other users, (3) receiving initial and subsequent evaluations from one or more raters either invited by the user or an unsolicited request by one or more individuals that desire to evaluate the user and/or serve on the user's “leadership panel,” (4) receiving either attributable or non-attributable comments from raters, (5) invoking an optional self-evaluation, (6) receiving an optional reciprocal invitation from users that received an invitation to evaluate the user, (7) sending additional invitations and receiving subsequent evaluations from users, (8) computing an overall leadership score and scores of leadership attributes and competencies, (9) conducting data analysis and generating additional information based on user ratings and demographics, and (10) displaying computed scores and the determined “leadership zone” to the user with the option of sharing with other users or to other social networks.

It will be apparent to one skilled in the art, that the present invention may be practiced without some or all of these specific details. In other instances, well known process steps and/or structures have not been described in detail in order to not unnecessarily obscure the present invention. Additionally, the embodiment disclosed below is not intended to be exhaustive or limit the invention to the precise font disclosed in the following detailed description.

### BRIEF DESCRIPTION OF THE DRAWINGS

FIG. 1 shows a block diagram of a client-server architecture, in the context of the present disclosure.

FIG. 2 shows a block diagram of the client-server architecture including functional components, in the context of the present disclosure.

FIG. 3 shows a computer system to evaluate and identify leadership talent among users and organizations in a social network, according to an embodiment of the present disclosure.

FIG. 4 shows an exemplary table including a computed overall leadership score, scores for each category of rater, leadership attributes and competencies ratings, and leadership zone for an individual, according to an embodiment of the invention.

FIG. 5 shows an exemplary table including a computed overall leadership score, scores for each evaluation category, leadership attributes and competencies ratings, and leadership zone for an individual, according to an embodiment of the invention.

FIG. 6 shows an exemplary graph segmented into leadership zones (I-V) based on an individual's overall leadership score and number of ratings, according to an embodiment of the invention.

FIG. 7 shows a flowchart of a computer-implemented method for identifying leadership talent among users and organizations in a social network by evaluating and assessing leadership abilities (attributes and competencies), according to an embodiment of the present disclosure:

FIG. 8 provides a detailed expansion of process block 710 in FIG. 7 and shows a flowchart for sending invitations to users to provide leadership evaluations, according to an embodiment of the invention.

FIG. 9 shows a flowchart depicting the process for sending unsolicited requests to provide leadership evaluations to another user, according to an embodiment of the invention.

FIG. 10 depicts a representative evaluation form used in the leadership evaluation data collection process, according to an embodiment of the invention.

### DETAILED DESCRIPTION OF THE DRAWINGS

The following description is presented to enable any person skilled in the art to make and use the disclosed embodiments, and is provided in the context of a particular application and its requirements. Various modifications to the disclosed embodiments will be readily apparent to those skilled in the art, and the general principles defined herein may be applied to other embodiments and applications without departing from the spirit and scope of the present embodiments. Thus, the system and methods are not limited to the embodiments shown, but is to be accorded the widest scope consistent with the principles and features disclosed herein.

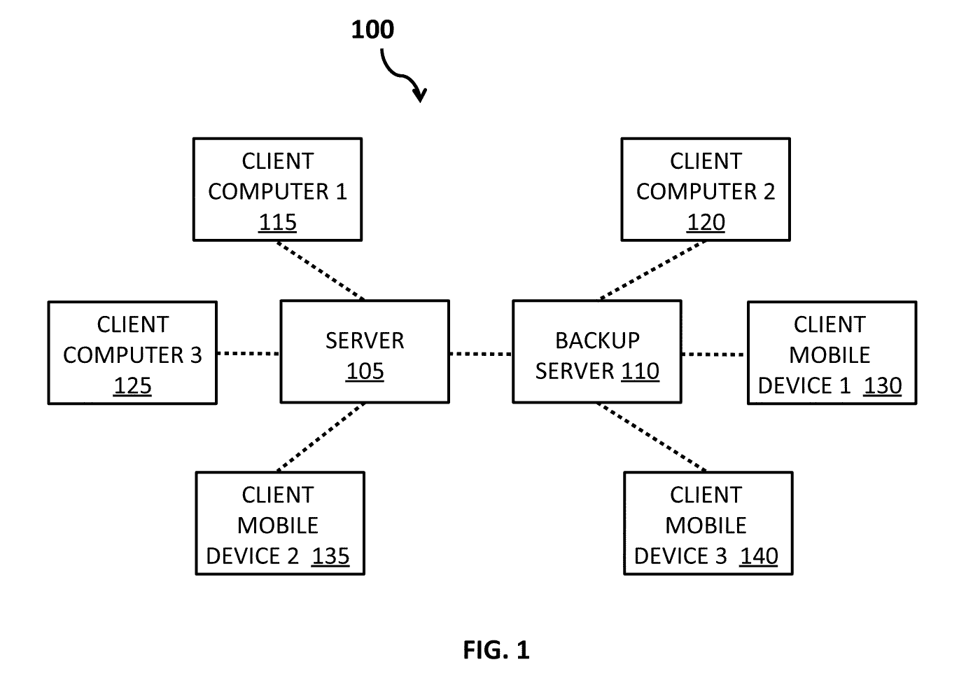

FIG. 1 illustrates a block diagram of client-server architecture 100 in the context of the present disclosure. The client-server architecture 100 includes a plurality of services such as secure server 105 and secure backup server 110, a plurality of client computers such as client computer 1 115, client computer 2 120, client computer 3 125, and a plurality of client mobile devices such as client mobile device 1 130, client mobile device 2 135, and client computer 3 140. The plurality of client computers may include, but is not restricted to, desktop computers or handheld mobile devices configured to access the internet and/or a social network system that may reside on the internet.

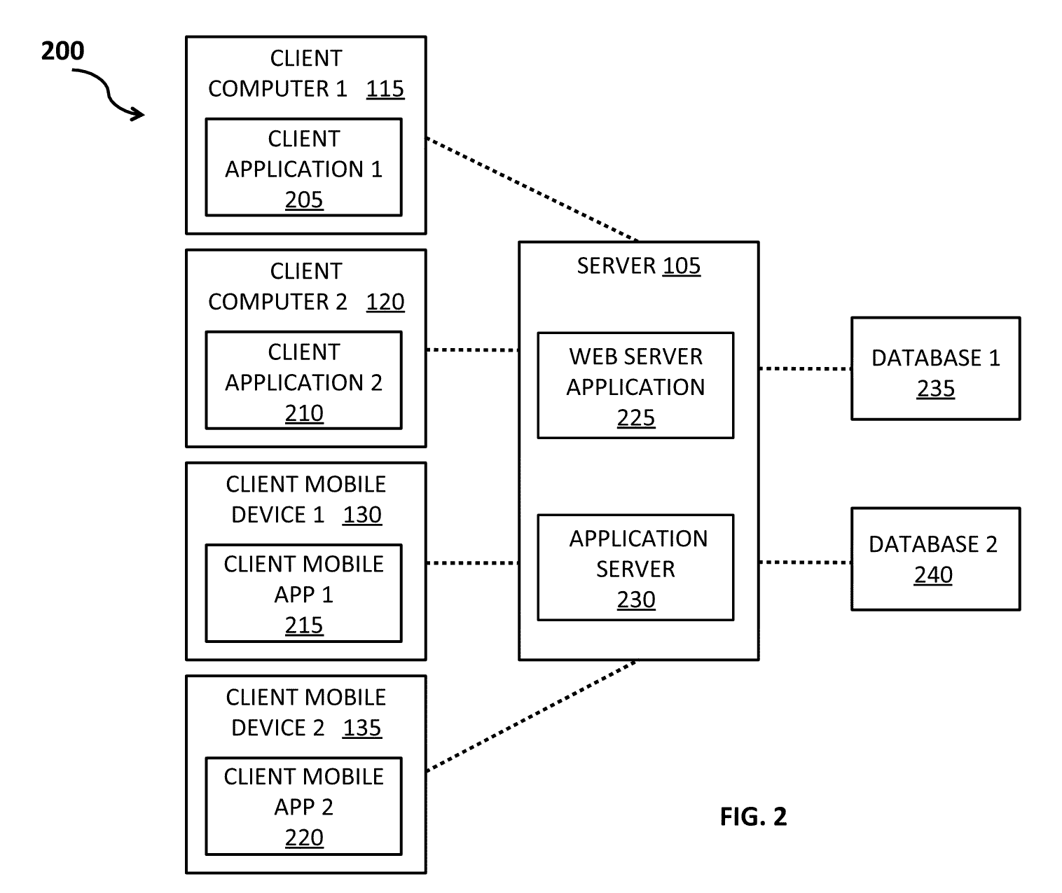

FIG. 2 illustrates a block diagram of the client-server architecture 200 including functional components, in the context of the present disclosure. The client-server architecture 200 includes client computer 115, client computer 120, client mobile device 130, and client mobile device 135 of FIG. 1. The client computer 115, the client computer 120, the client mobile device 130, and the client mobile device 135 further include client application 205, client application 210, client mobile application 215, and client mobile device 220 respectively. The client application 205 and client application 210 are configured to use a web browser known in the art to facilitate a user to create a user account and profile in a social network. The client mobile application 215 and client mobile application 220 are configured to use a mobile device operating system to create a user account and profile in a social network.

The client application 205 and client application 210 may reside in an on-board storage of the client-computer 115 and client computer 120, or may be stored on the secure server 105 connected to the client computer 115 and client computer 120 from where it can be downloaded using the web browser on demand. The client mobile application 215 and client mobile application 215 may reside in an on-board storage of the client mobile device 130 and client mobile device 135, or may be stored on the server 105 connected to the client computer 115, client computer 120, client mobile device 130, and client mobile device 135 from where it can be downloaded using the web browser or mobile device operating system on demand. The client application 205, client application 210, client mobile application 215 and client mobile application 220 are further configured to access server-side software that may reside on the server 105. The server 105 further includes a web server application 225 and an application server 230. The web server application 225 is capable of performing conventional web server functions. The server 105 has accesses to one or more secure/encrypted databases, such as database 1 235 and database 2 240, which communicate with the web server application 225 and the application server 230 and provide storage facility for these applications.

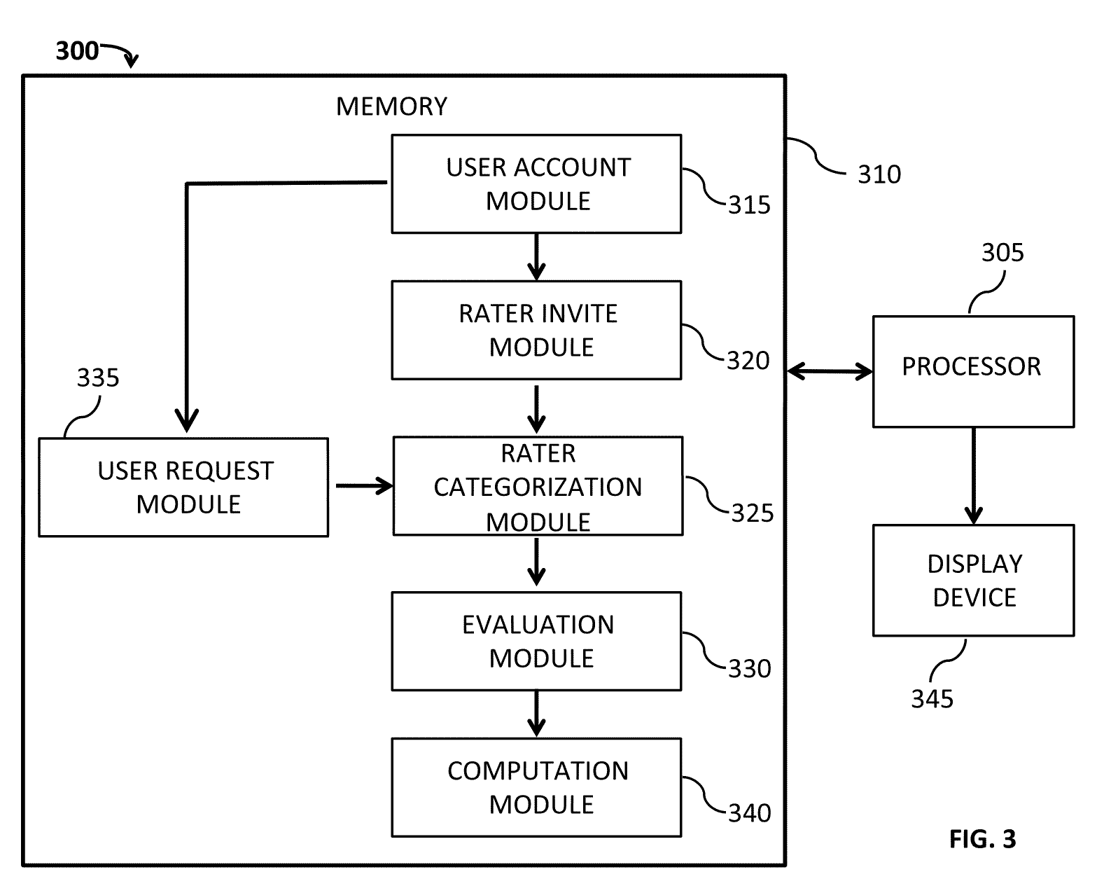

FIG. 3 illustrates a computer system 300 to evaluate and assess the leadership abilities of a user in a social network, according to an embodiment of the present disclosure. The computer system 300 includes a processor 305, a memory 310 and a display device 345. The memory 310 further includes a user account module 315, a rater invite module 320, a rater categorization module 325, an evaluation module 330, a user request module 335, and a computation module 340. The memory 310 comprises a non-transitory computer-readable medium. The user account module 315, rater invite module 320, rater categorization module 325, evaluation module 330, user request module 335, and computation module 340 comprise computer-readable instructions that may be executed by the processor 305. In one embodiment, the computer system 300 may reside in the application server 230 of FIG. 2. In another embodiment, the display device 345 may be a display of a client computer, which may include, but is not restricted to, desktop computers or handheld mobile devices configured to access web pages. In yet another embodiment, the display device 345 may be a display of the server 105 or the application server 230.

The user account module 315 is configured to create a user account and profile. A user who can be an individual and/or an organization creates the user profile. The user account module 315 is further configured to request the user to enter personal and professional information. The personal and professional information entered by the user may include, but is not restricted to, name, contact information, present employment details, previous employment details, education details, and so on. Upon creating the user profile, a unique identifier (ID) is created by the user account module 315, and the personal and professional information entered by the user is associated and securely stored in the memory 310 along with the created unique ID.

Upon the establishment of an account and profile by a user, the rater invite module 320 sends invites to a one or more raters, who may be selected by the user for evaluating and rating the user and/or serve on the user's “leadership panel,” upon receipt of an appropriate request from the user. The rater invite module 320 is further configured to generate an optional reciprocal invitation back to the user to also evaluate and rate the user they just invited. The evaluation and ratings are carried out with respect to the rater's knowledge and observations of the user's leadership attributes and competencies. The rater invite module 320 may also store information about the raters in the memory 310 and set the status of rating to pending, not-available, or completed. Raters are further categorized by the rater categorization module 325 based on the rater's professional relationship to the user as junior, peer, senior, or other. The user request module 335 is also configured to allow users to request to provide evaluations and ratings to another user. The tem “360-feedback” is applied to describe raters from various hierarchal levels in relation to the user. The term “leadership panel” is used to describe raters that have agreed to provide evaluations to the user. The rater categorization module 325 is further configured to record and categorize all evaluations received from user's “leadership panel.”

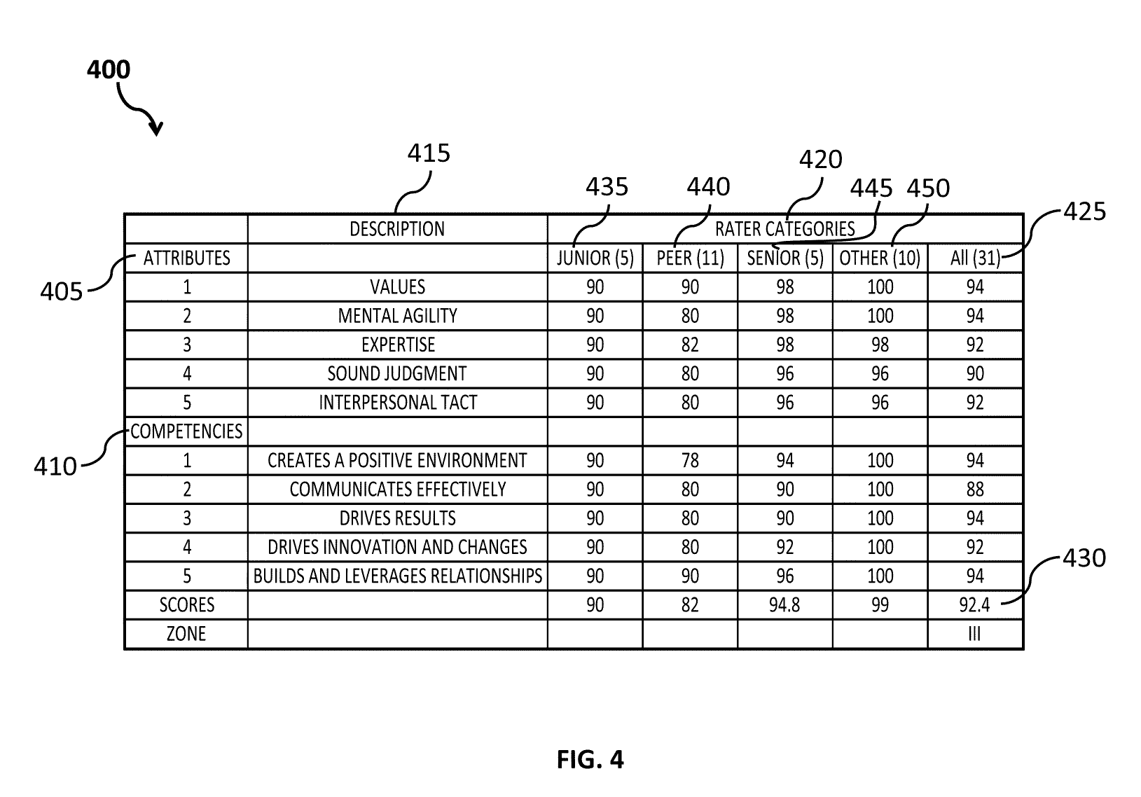

FIG. 4 illustrates one embodiment of leadership evaluations and ratings 400. Upon a rater acceptingthe invite from the user, the evaluation module 330 presents the rater an evaluation form comprising of, but not limited to leadership attributes 405 such as values, mental agility, expertise, sound judgment, interpersonal tact and leadership competencies 410 including, but not limited to creates a positive environment, communicates effectively, drives results, drives innovation and change, and builds and leverages relationships. The rater evaluates the user by selecting descriptors such as “unacceptable performance,” “low performance,” “good performance,” “excellent performance,” and “exceptional performance.” Numerical values from 1-5 are assigned with 5 representing the most favorable description, “exceptional performance.” Scores may be converted to a 100-point or similar scale. The evaluation module 330 captures the ratings entered by the rater in the evaluation form and stores it in the memory 310 along with the unique ID Of the user. In a further embodiment, the evaluation module 330 is configured to also capture the category of the rater and the category of the evaluation. The evaluation module 330 is further configured to receive comments in the form of text, from a rater, against each evaluation or subsequent evaluation. The evaluation module 330 is further configured to allow raters to keep their comments anonymous or present the rater name against the comments posted (attributable versus non-attributable.) The evaluation module 330 is further configured to automatically notify the user upon receipt and posting of new comments.

Upon completing the evaluation form, the status of the evaluation is set to “complete” by the rater invite module 320, and the computation module 340 is notified. The computation module 340 is configured to access ratings captured by the rating module 320 in the evaluation form, and compute an overall leadership score 430, and scores of the user's leadership attributes 405 and leadership competencies 410 based on the evaluations received from the rater in relation to their knowledge and observations of the user's performance as a leader. The computation module 340 is further configured to automatically notify the user upon updating the user's overall leadership score 430, and the scores of the user's leadership attributes 405 and competencies 410.

In one embodiment, the computation module 340 accesses the leadership evaluation forms of all raters in the memory 310 and computes an aggregate leadership score 430, scores for each of the leadership attributes 405, and scores for each of the leadership competencies 410. The computed leadership score 430, scores for each of the leadership attributes 405, scores for each of the leadership competencies 410, and aggregate number of ratings 425 are associated with the unique ID of the user and stored in the memory 310. In another embodiment, the evaluation module 330 is configured to limit the number of ratings received from a rater during a specified period of time. For example, a rater may be limited to three ratings within a 90-day period. In another embodiment, the user may request to “reset” their scores due to a job/position change or after a period of time.

The computed leadership score 430, scores for each of the leadership attributes 405, and scores for each of the leadership competencies 410 are then displayed to the user whenever the user accesses the user account. The aggregate number of ratings 425 used to calculate the scores are also displayed to the user. The user has the option to display the computed leadership score 430, scores for each of the leadership attributes 405, scores for each of the leadership competencies 410, and the aggregate number of ratings 425 to the social network, selected users, or share with other social networks. In one embodiment, the computed leadership score 430, scores for each of the leadership attributes 405, and scores for each of the leadership competencies 410 are calculated based on the category of the rater 420 and the aggregate number of ratings 425 for each category. One embodiment of rater categories includes junior 435, peer 440, senior 445, and other 450.

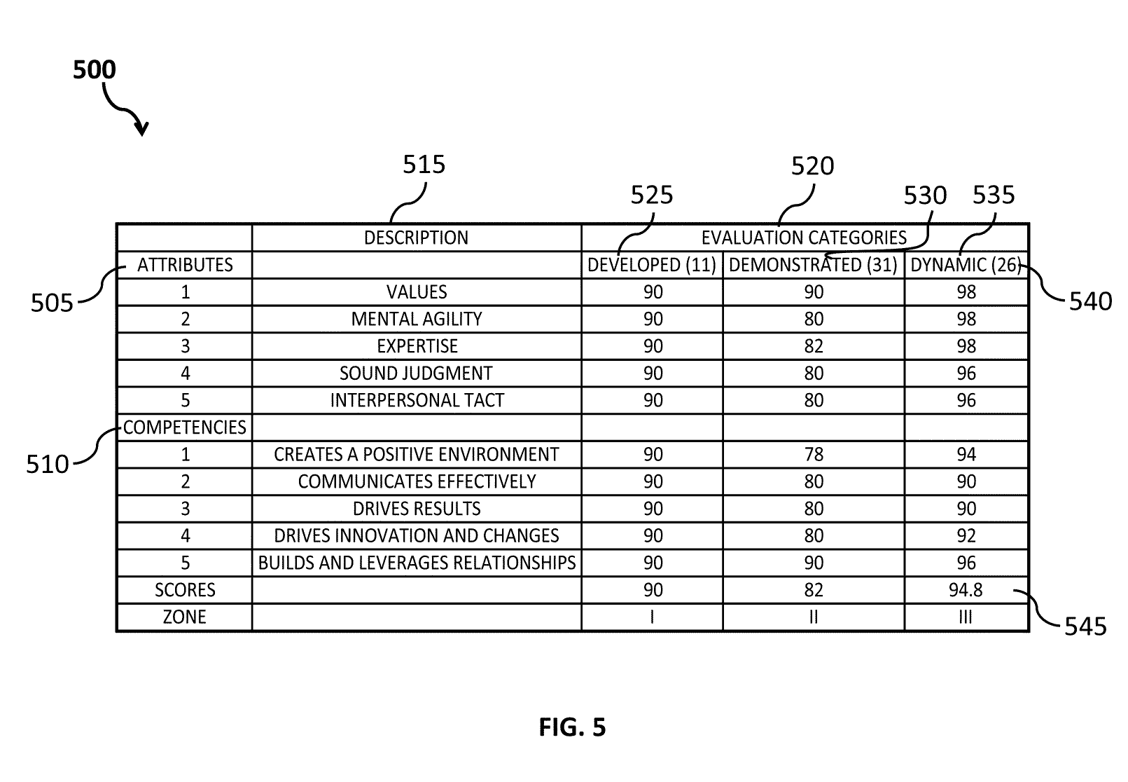

FIG. 5 illustrates another embodiment of leadership evaluations and ratings based on the category of the evaluation 500. The computed leadership score 545, scores for each of the leadership attributes 505, and scores for each of the leadership competencies 510 are calculated based on the evaluation category 520 and the aggregate number of ratings 540 for each category. In another embodiment, the computed leadership score 545, scores for each of the leadership attributes 505, scores for each of the leadership competencies 510 and the aggregate number of ratings 540 are displayed only after reaching a certain threshold limit such as receipt of ten or more ratings and/or receipt of ten or more ratings per rater category 420 and/or receipt of ten or more ratings per evaluation category 520.

Evaluations may be categorized as initial, subsequent/event-driven, or subsequent/issue-driven. Initial evaluations provide ratings that address how leadership skills, termed “developed skills 525,” were applied in the past. Subsequent/event-driven evaluations provide ratings that address how leadership skills, termed “demonstrated skills 530,” are being applied to present events. Subsequent/event-driven evaluations address the leader's attributes and competencies in relation to how they influenced the outcome of a recent event. Subsequent/issue-driven evaluations provide ratings that address how leadership skills, termed “dynamic skills 535”, are being applied to influence the future. Subsequent/issue-driven evaluations address the leader's attributes and competencies in relation to how they influence the immediate climate and longer-term culture of a workplace environment. The evaluation process in its entirety is termed “360×3-D Feedback” whereas 360 is “360 degrees” and 3-D is “three-dimensional.”

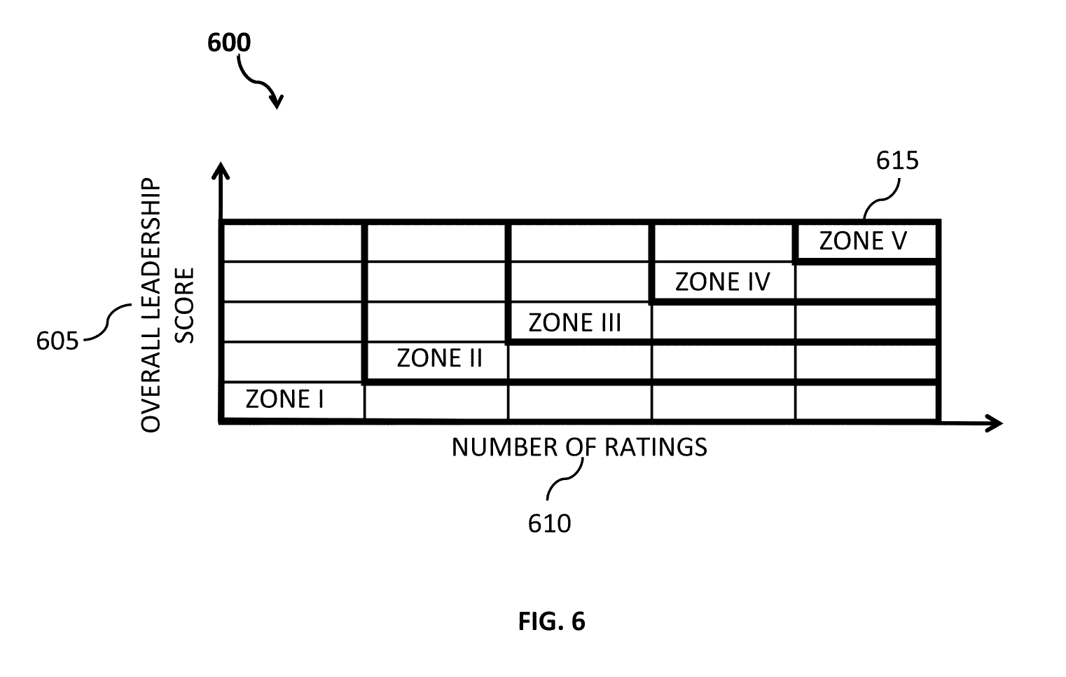

FIG. 6 illustrates another embodiment where users are segmented into zones 600, based on the overall leadership score 605 and the aggregate number of ratings 610. The Cartesian coordinate system in two dimensions is used where the aggregate number of ratings received by a user defines the x-coordinate 610 and the overall leadership score defines the y-coordinate 605. The x and y-axes are numerical ranges fragmented by defined intervals that correspond in linear fashion and result in the establishment of zones 615. Plotting the aggregate number of ratings and the overall leadership score as an ordered pair (x, y) places the user in “leadership zone.” Advancing to a higher zone (from I to V) is dependent on a higher leadership score and a pre-defined higher number of ratings. The computation module 340 is further configured to determine the user's leadership zone based on computation of the overall leadership score 605 and the aggregate number of ratings 610. In another embodiment, the computed leadership zone 615 is displayed to the user only after reaching a certain threshold limit such as receipt of ten or more ratings. The computed leadership zone 615 is associated with the unique ID of the user and stored in the memory 310. The user has the option to display the computed leadership zone 615 to the social network, selected users, or share with other social networks.

In another embodiment, the computer system 300 described above is also used to evaluate the leadership of an entire organization wherein the user being an organization may be evaluated and rated for the performance of its leaders (as an aggregate or individual) by employees. In one embodiment, the organization may be divided into several organizational units such as parent, subsidiary, service line, functional units, and so on. Further, each of the organizational units may be evaluated by one or more raters (employees) generating an overall leadership score 430, scores of the unit's general leadership attributes 405 and leadership competencies 410 computed based on the evaluations received from the raters (employees) in relation to their knowledge and observations of aggregate or individual leadership performance within an organization or subdivision.

In another embodiment, an aggregate or individual leadership score 430, scores of the organization, subdivision, or individual leadership attributes 405, leadership competencies 410, and number of ratings 425 may be displayed by aggregating the ratings and scores received for each organizational unit or individual. In another embodiment, the computation module 340 is configured to not use any or some of the ratings received for the sub-organization units in calculating the leadership score 430, scores of the unit's general or individual leadership attributes 405 and leadership competencies 410 based on the raters being external or internal to the organization or sub-organization unit. In another embodiment, the computer system 300 described above is an enterprise system restricted to employees of an organization.

In another embodiment, human resource units of an organization may use the system 300 to evaluate users for appraisals and performance reviews, wherein the users comprise employees that occupy leadership roles within the organization. In yet another embodiment, hiring managers and/or recruiters of an organization may use the system 300 to evaluate the leadership scores of users for hiring purposes, wherein the users comprise candidates applying for a position and/or users that display their scores to the social network or selected individuals with the option of receiving communications from recruiters or hiring managers.

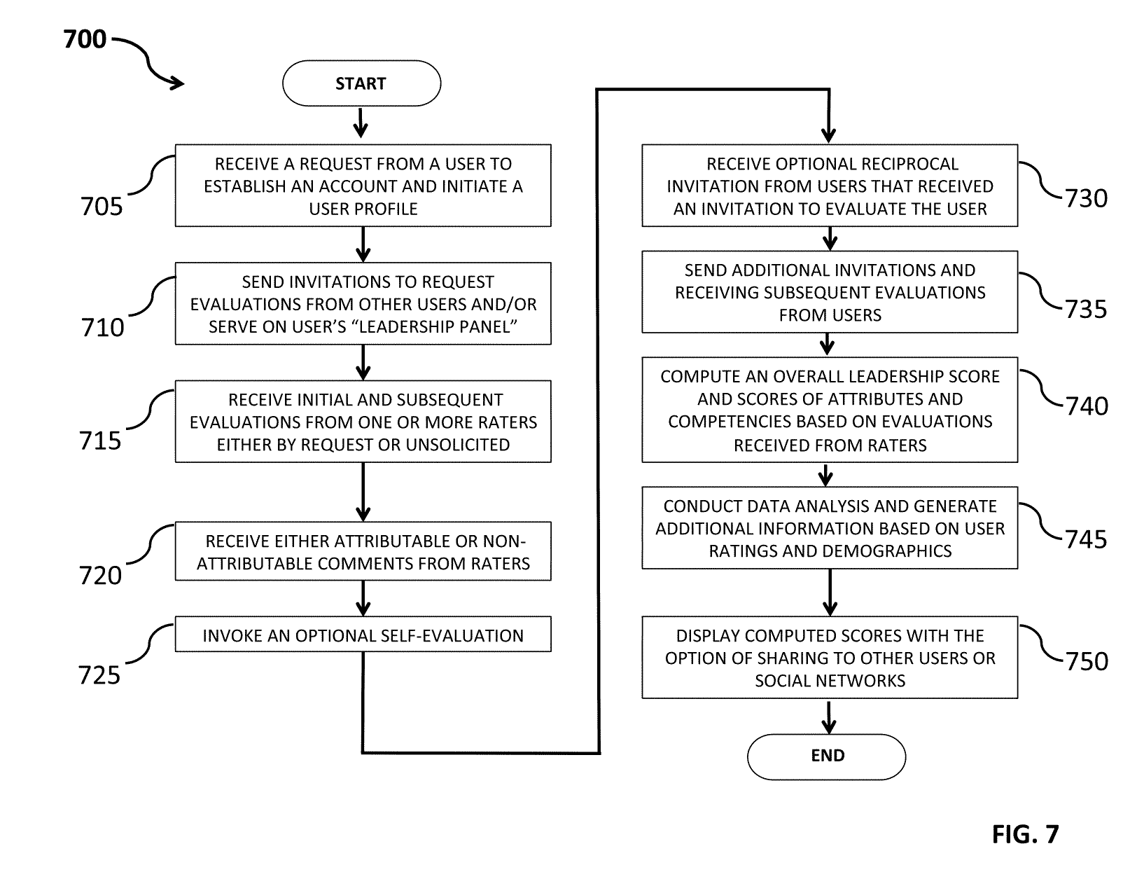

FIG. 7 illustrates a flowchart 700 of a method for evaluating and assessing leadership abilities of users and organizations in a social network, according to an embodiment of the present disclosure. At process block 705, a request is received from a user to establish an account and initiate a user profile. Upon creating the user account, a unique ID is created for the user. The user may include, but is not limited to, an individual and/or an organization or a sub-unit of an organization, e.g., a subsidiary or business unit. Further, the user may create the user profile by entering personal and professional information. The personal and professional information entered by the user includes, but is not restricted to, name, contact information, present employment details, previous employment details, education details, and so on. The personal and professional information entered by the user in the user profile is associated with the unique ID and stored in a secure/encrypted database.

At process block 710, the user sends invitations to request evaluations from other users in the network or individuals that will join the network to serve on the user's “leadership panel.” Users can submit a single evaluation or multiple/subsequent evaluations as implied by serving on the “leadership panel.”

At process block 715, evaluations/ratings are received from one or more raters either invited by the user or as a result of an unsolicited request to the user from another user. The rating includes presenting an evaluation form to the rater comprising of, but not limited to leadership attributes 405 such as values, mental agility, expertise, sound judgment, interpersonal tact and leadership competencies 410 including, but not limited to creates a positive environment, communicates effectively, drives results, drives innovation and changes, and builds and leverages relationships. The rater evaluates the user by selecting descriptors such as “unacceptable performance,” “low performance,” “good performance,” “excellent performance,” and “exceptional performance.” Numerical values from 1-5 are assigned with 5 representing the most favorable description, “exceptional performance.” Scores may be converted to a 100-point or similar scale.

At process block 720, the user can also receive either attributable or non-attributable comments from raters in the form of free-flowing text. This is an option for all raters. The user will also have the option of displaying comments to the network, selected individuals, or sharing with other networks.

At process block 725, the user has the option of invoking a self-evaluation module. The user will also have the option of displaying the self-evaluation to the network, selected individuals, or sharing with other networks.

At process block 730, the user may receive a reciprocal invitation to serve as a rater for the same user that they just requested an evaluation from. This is an option for all users that receive a request from someone to evaluate their leadership attributes and competencies.

At process block 735, the user may send additional invitations for subsequent evaluations as a result of a recent event, work place issue, or the elapse of time.

At process block 740, ratings entered by the rater in the evaluation form are used to compute an aggregate leadership score 430, scores for each of the leadership attributes 405, and scores for each of the leadership competencies 410.

At process block 745, data analysis is conducted to generate additional scores and information. For example, evaluations may be categorized as initial, subsequent/event-driven, or subsequent/issue-driven. In one embodiment, the computed leadership score 545, scores for each of the leadership attributes 505, scores for each of the leadership competencies 510, and the aggregate number of ratings 540 for each evaluation category thereby providing a scoring profile of “developed” or past leadership scores versus “demonstrated” or scores that represent how a leader influences current events versus “dynamic” or scores that represent how a leader influences the future or long-term working environment. Scores may get analyzed and segmented based on various categories of information received from the evaluation form. For example, raters may be categorized by the rater categorization module 325 based on the rater's professional relationship to the user as junior 435, peer 440, senior 445, or other 450. In one embodiment, the computed leadership score 430, scores for each of the leadership attributes 405, and scores for each of the leadership competencies 410 are computed based on the category of the rater 420 and the aggregate number of ratings 425 for each category.

In another embodiment, the leadership score 430 is computed only from ratings of the leadership attributes 405, whereas another leadership score is computed only from ratings of the leadership competencies 410, thereby allowing for comparisons of ratings for the user's leadership attributes 405 versus leadership competencies 410.

At process block 750, computed scores, rater comments, and additional information is displayed to the user with the option of sharing to the network, selected users, or other social networks.

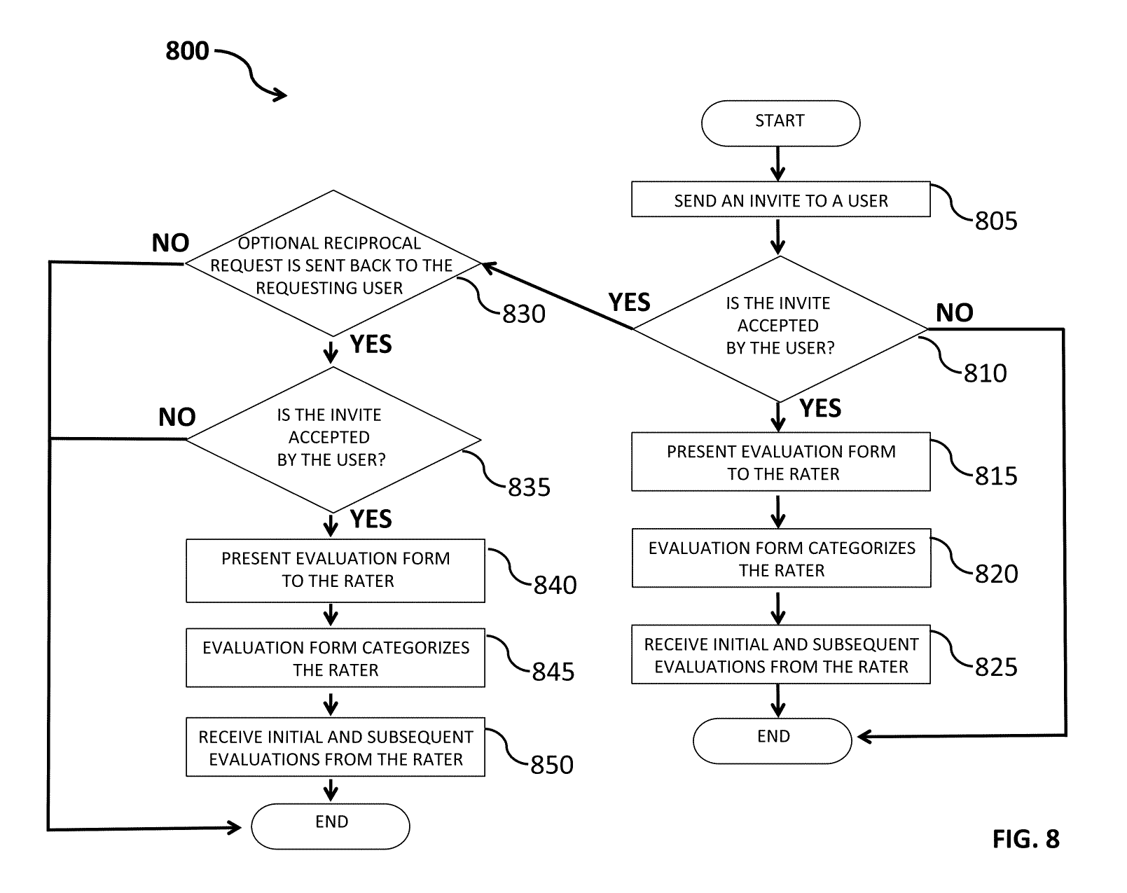

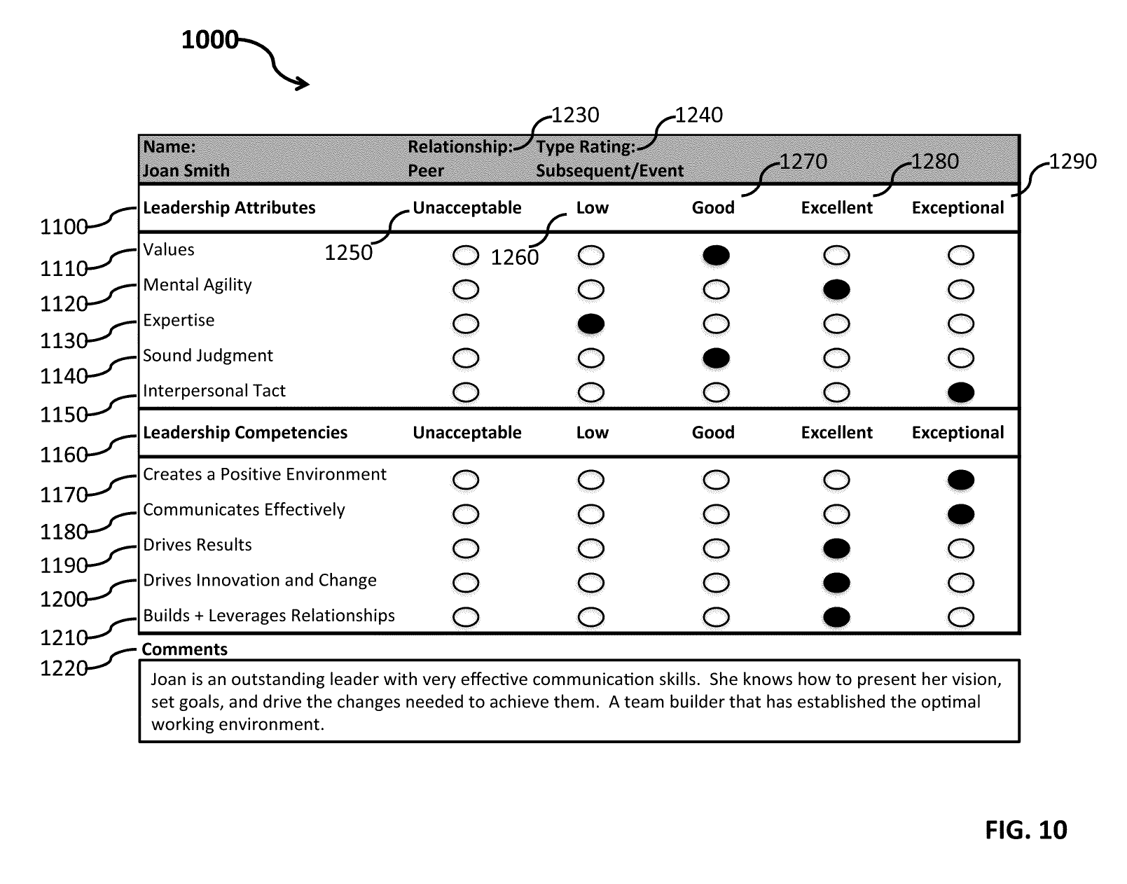

FIG. 8 provides a detailed expansion of process block 710 in FIG. 7. The process is initiated at block 805 where a user sends an invitation to another user to provide an evaluation or serve on his/her “leadership panel” to provide ongoing evaluations. At block 810, the user either accepts or declines the invitation. If accepted, the user becomes a rater and is presented an evaluation form 815 as shown in FIG. 10, which provides one possible embodiment. The rater is also presented with the option to send a reciprocal request 830 back to the user for an evaluation or the serve on their “leadership panel” as well. In both cases where users accept the invitation to provide an evaluation or serve on a “leadership panel” and provide ongoing evaluations raters are presented with evaluation forms 815/840. The evaluation forms also serve to categorize the rater 820/845 by defining their relationship to the user they are rating as junior 435, peer 440, senior 445, or other 450. Users will then receive either initial and/or subsequent evaluations from the rater 825/850.

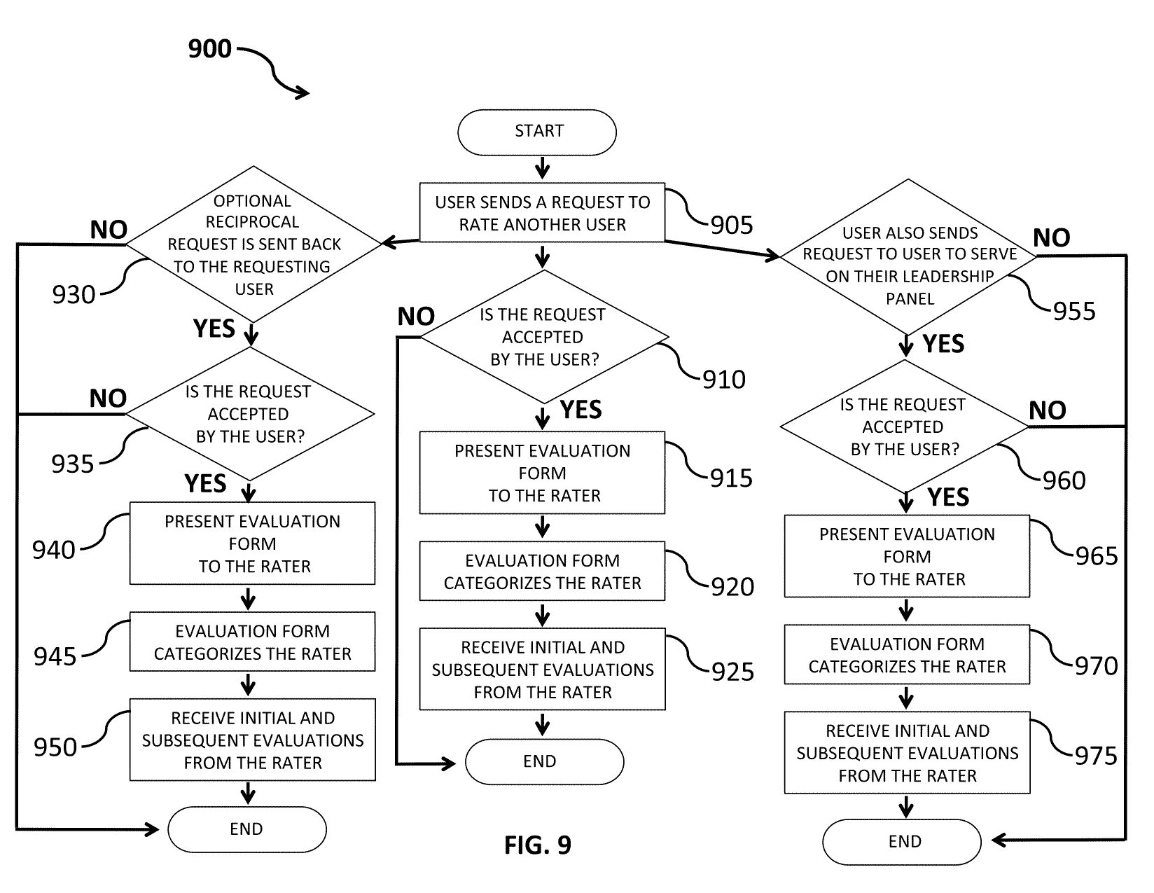

FIG. 9 illustrates the process where a user initiates an unsolicited request to evaluate or serve on another user's “leadership panel.” The process is initiated at block 905 where a user sends an unsolicited request to another user to provide an evaluation and/or serve on his/her “leadership panel” to provide ongoing evaluations. The initiating user also has the option of requesting the user to provide an evaluation or serve on their “leadership panel” to provide ongoing evaluations 955. Additionally, the unsolicited request generates an optional reciprocal request that allows the user (recipient of the unsolicited request) to request to provide an evaluation and/or serve on the “leadership panel” to provide ongoing evaluations to the user that made the unsolicited request 930. At blocks 910/935/960, the user either accepts or declines the invitation. If accepted, the user becomes a rater and is presented an evaluation form 915/940/965 as shown in FIG. 10, which provides one possible embodiment. The evaluation form also serves to categorize the rater by defining their relationship to the user they are rating as junior, peer, senior, or other 920/945/970. Users will then receive either initial and/or subsequent evaluations from the rater 925/950/975.

FIG. 10 provides an example of one possible embodiment of an evaluation form 1000. The rater evaluates the user by selecting performance descriptors such as unacceptable performance 1250, low performance 1260, good performance 1270, excellent performance 1280, and exceptional performance 1290.

Exceptional performance 1290—Leader's performance is exceptional and far exceeds performance of peers. This may include one of the following: exceeds goal targets, exceeds expectations in spite of unusually challenging circumstances, leader's performance influences others to perform better, by either naturally motivating and inspiring others to perform better, coaching others, or creating results that pave the way for others and/or are used as a model.

Excellent performance 1280—Leader's performance is excellent and completely satisfactory. The next step for this leader would be to exceed targets, and/or influence others to improve their performance. Leader requires little guidance to perform at a high level.

Good performance 1270—Leader's performance is good, but still has room for growth. Leader requires occasional guidance for performance to be completely satisfactory.

Low performance 1260—Leader shows potential, but performance is low. Leader may be new to the job or task and is developing. Leader requires frequent guidance.

Unacceptable performance 1250—Leader's performance is poor and requires significant improvement in the short-term. Leader may actually be doing things that negatively affect others' performance, or puts the organization at risk.

Numerical values from 1-5 are assigned to the performance descriptors with 5 representing the most favorable description, exceptional performance 1290. Scores may be converted to a 100-point or similar scale.

Leadership attributes 1100 describe how an individual behaves and learns within an environment. Leadership attributes represent the identity of the leader, how the leader is Perceived by followers and others, and includes the mental and social faculties the leader applies in the act of leading. In this embodiment the leader attributes are values 1110, mental agility 1120, expertise 1130, sound judgment 1140, and interpersonal tact 1150.

Values 1110, such as the Army Values (Loyalty, Duty, Respect, Selfless Service, Honor, Integrity, and Personal Courage) are expressed by organizations with the expectation that leaders practice them. When there is alignment between the expressed and practiced values, leaders within the organization are perceived to operate out of personal integrity. When there is a disconnect between the expressed and practice values that's called hypocrisy. Leadership functions on the basis of trust and credibility. That's why leaders must become consciously aware of closing the gap between the expressed values and the values they practice. Leaders who live their values inspire a tremendous sense of commitment and loyalty in others. As a result they expand their influence and their ability to affect change. Users will score the values attribute 1110 based on how well the leader practice a given set of values such as respect, integrity, diversity, empowerment, humility, honesty, and genuine concern. In the case of an enterprise system, users will score the values attribute 1110 based on how well the leader practiced the values specifically expressed by the organization.

Mental agility 1120 relies upon inquisitiveness and the ability to reason critically. Inquisitive leaders are eager to understand a broad range of topics and keep an open mind to multiple possibilities before reaching an optimal solution. Critical thinking is a thought process that aims to find facts, to think through issues, and solve problems. Central to decision-making, critical thinking enables understanding of changing situations, arriving at justifiable conclusions, making good judgments, and learning from experience. Creative thinking involves thinking in innovative ways while capitalizing on imagination, insight, and novel ideas. Critical thinking examines a problem in depth from multiple points of view. This is an important skill for leaders—it allows them to influence others and shape organizations. The first and most important step in finding an appropriate solution is to isolate the main problem. A leader's mental agility to quickly isolate a problem and identify solutions generates initiative to adapt during operations. Leaders must instill agility and initiative within subordinates by creating a climate that encourages participation and trust.

Expertise 1130 is the special knowledge and skill developed from experience, training, and education. Domain knowledge is what leaders know about application areas used in their duties and positions. Their knowledge allows them to employ individuals, teams, and organizations effectively to achieve objectives and goals. At higher levels, the technical knowledge requirement shifts from understanding how to operate single items to employing entire systems. Higher-level leaders have a responsibility to understand capabilities and the organizational impact. Some organizational and strategic level leaders have general oversight responsibility for new system development. Their interests lay in understanding how systems affect the organization. Culture consists of shared beliefs, values, and assumptions about what is important. Leaders must be mindful of cultural factors within the workplace environment particularly the different backgrounds of team members to best use their talents.

Sound judgment 1140 requires the capacity to assess situations shrewdly and to draw rational conclusions. Consistent good judgment enables leaders to form sound opinions and make reliable estimates and sensible decisions. Leaders acquire experience through trial and error and by observing others. Learning from others can occur through mentoring and coaching by superiors, peers, and even subordinates. Often, leaders must juggle facts, questionable data, and intuitive feelings to arrive at a quality decision. Good judgment informs the best decision for the situation. It is a key attribute of transforming knowledge into understanding and quality execution. Sound judgment contributes to an ability to determine possible courses of action and decide what action to take. Before choosing, leaders consider the consequences. Good judgment includes the ability to assess a situation or problem set for strengths and weaknesses to create appropriate solutions and action. Like mental agility, it is a critical part of problem solving and decision-making.

Interpersonal tact 1150 to effectively interact with others depends on knowing what others perceive. It relies on accepting the character, reactions, and motives of oneself and others. Interpersonal tact combines these skills, along with recognizing diversity and displaying self-control, balance, and stability in situations. By acknowledging differences, qualifications, contributions, and potential, leaders further strengthen the team effort by creating an environment where subordinates know they are valued for their talents, contributions, and differences. Effective leaders control their emotions. Leaders should display the right amount of sensitivity and passion to tap into subordinates' emotions, instead of hysterics or lack of emotion. Maintaining self-control inspires calm confidence in the team. Self-control encourages feedback from subordinates that can expand understanding of what is really happening. Emotionally balanced leaders are able to display the right emotion for a given situation and can read others' emotional state. They draw on experience to provide subordinates the proper perspective on unfolding events. They have a range of attitudes, from relaxed to intense, with which to approach diverse situations. They know how to choose what is appropriate for the circumstances. Balanced leaders know how to convey urgency without throwing the entire organization into chaos.

Leadership competencies 1160 develop from a balanced combination of institutional schooling, self-development, realistic training, and professional experience. Building competence follows a systematic and gradual approach, from mastering individual competencies to applying them in concert and tailoring them to the situation at hand. Leading people by giving them a complex task helps them develop the confidence and will to take on progressively more difficult challenges. Competencies provide a clear and consistent way of conveying expectations for leaders. Current and future leaders want to know how to be successful leaders. The core leader competencies apply across all levels of leader positions and throughout careers, providing a good basis for evaluation and focused feedback. A spectrum of leaders and followers (superiors, subordinates, peers, and mentors) can observe and assess competencies demonstrated through behaviors. In this embodiment the leadership competencies are creates a positive environment 1170, communicates effectively 1180, drives results 1190, drives innovation and change 1200, and builds and leverages relationships 1210.

Creates a positive environment 1170—Leader creates a high commitment work environment where employees are motivated and encouraged to achieve through empowerment and development. Takes accountability for building a team with diverse leadership and technical skills. Strengthens the organization or team's reputation as a place of choice. High performance behaviors include: (1) partners with employees to create development plans aligned with goals and future career aspirations, (2) diagnoses the strengths and development opportunities within the unit/team and uses the right leadership style for the situation, (3) praises, rewards and recognizes high performance, (4) effectively confronts and resolves difficult people issues affecting individual and team performance, (5) provides timely, clear and actionable performance feedback, (6) effectively uses recruitment & retention techniques to create a diverse, high performing team for now and the future, (7) keeps team and employees motivated; monitors workload, morale and satisfaction to drive high performance, (8) makes time to speak to subordinates and peers; is accessible, and (9) promotes a culture and climate of trust. Low performance behaviors include: (1) does not identify development opportunities for others; fails to implement development plans, (2) misdiagnoses team development and uses limited and inappropriate leadership styles, (3) misses opportunities to praise, reward and recognize high performance, (4) allows low performers sanctuary in the organization, (5) misses opportunities and/or waits too long to provide useful feedback, (6) recruits people irrespective of their likely potential; misses opportunities to retain talented staff, (7) allows the mood and workload of the team to go unnoticed, (8) fails to make time to speak to subordinates and/or peers, and (9) failed to cultivate a climate of trust; displayed a willingness to tolerate discrimination or harassment; eroded unit cohesion and broke the trust of subordinates.

Communicates effectively 1180—Communicates openly and confidently. Influences, and convinces others in a way that results in acceptance and agreement. Shapes conversations to ensure focus and understanding. Speaks frankly, debates at the table, not afterwards; engages in constructive confrontation. Is a supportive listener. High performance behaviors include: (1) is clear when explaining ideas and concepts to others, communication is structured and easy to understand, (2) compelling and has impact, creates a credible impression, (3) adapts communication style, content and medium to suit the audience, (4) uses persuasion to gain agreement, (5) speaks up and shares views, (6) talks openly and honestly; says it as it is, (7) actively listens and incorporates input from others, and (8) ensures shared understanding and addresses misunderstandings. Low performance behaviors include: (1) is unclear or ambiguous when explaining ideas and concepts to others; communication is difficult to understand, (2) is hesitant; lacks impact and loses credibility, (3) uses the same communication style for all audiences, (4) rarely gains agreement; does not persuade or influence others, (5) waits until it is too late to speak up; doesn't say what is on their mind, (6) avoids voicing contrary opinions, (7) pretends to listen to others but does nothing to incorporate their input; is not accessible for others, and (8) causes misunderstandings and confusion; does not check others' understanding of a situation.

Drive results 1190—Takes personal accountability for achieving individual and shared goals. Sets robust plans well in advance and initiates action to move projects forward. Adjusts actions to respond and capitalize on changing circumstances. Manages time effectively, monitoring performance against deadlines and milestones. High performance behaviors include: (1) sets clear objectives, defining metrics and key milestones to plan and organize work, (2) Prepares well in advance to maximize resource and time, (3) continually looks for contingency options and proactively adapts plans and priorities, (4) manages multiple tasks effectively—progresses work in parallel, (5) tracks progress of work and initiates actions when projects are stalling, (6) takes the initiative to create clarity when changing circumstances cause ambiguity, (7) knows when to escalate decisions and when to make on-the-spot decisions, and (8) handles problems and acts on own initiative without being prompted. Low performance behaviors include: (1) sets unclear and confusing objectives, responsibilities and parameters for work, (2) is not prepared or organized in advance, (3) fails to ensure a back-up plan and does not adapt to changing demands, (4) allows tasks to drop or remain undone putting work at risk, (5) allows priority work to stall; does not make decisions on own, (6) overloads self/others in failing to clarify ambiguity, (7) incorrectly assesses what to take up for decision-making, and (8) continually seeks guidance; fails to initiate actions.

Drives innovation and change 1200—Carries out systematic and rational analysis to identify the root cause of problems. Is prepared to challenge the status quo and drive innovation. Makes informed judgments. Generates creative ideas/solutions. Knows when to adopt existing ideas and when to invent. High performance behaviors include: (1) analyzes complex information and identifies the most relevant details, (2) assesses information from different angles and various sources to discover the root cause of the issue, (3) uses breakthrough thinking to generate insights, alternatives and opportunities for unit successes, (4) uses an appropriate balance of intuition and facts to make good judgements, (5) takes reasonable risks to innovate, (6) challenges the status quo, questions current approaches, (7) seeks continuous improvement by considering solutions that make novel use of existing ideas, approaches, technologies or products, and (8) identifies a number of ways to do things differently that will continuously improve the organization. Low performance behaviors include: (1) has difficulty analyzing complex issues; gets lost on irrelevant details, (2) takes a narrow view of issues; only looks at issues from one angle and a few sources; does not seek to find the root cause of issues, (3) fails to generate insights or offer opportunities for unit success, (4) recommendations are not thought through or are based on incomplete analysis, (5) misses opportunities rather than taking risks; is overly cautious, (6) constrained by the way it's always been done; does not challenge the status quo, (7) avoids different ways of doing things; sticks to tried and tested methods and approaches; resists change even when the situation clearly calls for it and, (8) uses the same method throughout and avoids different ways of doing things.

Builds and leverages relationships 1210—Coordinates efforts/resources within and external to the unit to deliver goals. Recognizes the importance of teamwork to achieve objectives; brings in ideas, information, suggestions and expertise from others outside of the unit. Builds strong team relationships within organization. High performance behaviors include: (1) shares critical expertise and knowledge to support unit, (2) learns from others and leverages best practices, (3) uses networks inside and outside the unit to provide support in delivering goals, (4) involves the right people to ensure the best decisions are made in a timely manner, (5) proactively supports colleagues and collaborates with them to help achieve targets, (6) actively seeks input from others—encourages and listens to different viewpoints and perspectives, (7) creates a positive unit/team environment through co-operation, and (8) proactively helps people understand their role in projects or groups. Low performance behaviors include: (1) encourages a climate where knowledge is seen as power and is withheld, (2) misses opportunities to learn from others or from best practices, (3) does not sustain effective networks and therefore misses opportunities for support from internal or external relationships, (4) makes decisions alone rather than involving appropriate people, (5) does not collaborate with unit members to progress work, (6) makes no effort to accept different viewpoints and backgrounds—fails to take the views of others into account, (7) does not work well in teams; prioritizes own agenda, and (8) does not help others understand their roles/responsibilities.

The evaluation form may also serve to categorize the rater by defining their relationship 1230 to the user they are rating by selecting junior, peer, senior, or other from a drop down list. Evaluations may be categorized by type of rating 1240 by selecting initial, subsequent/event-driven, or subsequent/issue-driven from a drop down list. Initial evaluations provide ratings that address how leadership skills, termed “developed skills 525,” were applied in the past. Subsequent/event-driven evaluations provide ratings that address how leadership skills, termed “demonstrated skills 530,” are being applied to present events. Subsequent/event-driven evaluations address the leader's attributes and competencies in relation to how they influenced the outcome of a recent event. Subsequent/issue-driven evaluations provide ratings that address how leadership skills, termed “dynamic skills 535”, are being applied to influence the future. Subsequent/issue-driven evaluations address the leader's attributes and competencies in relation to how they influence the immediate climate and longer-term culture of a workplace environment. The evaluation process in its entirety is termed “360×3-D Feedback” whereas 360 is “360 degrees” and 3-D is “three-dimensional.” The evaluation form also allows attributable or non-attributable comments 1220 from raters in the form of free-flowing text. This is an option for all raters. The user (leader) will also have the option of displaying comments to the network, selected individuals, or sharing with other networks.

The foregoing descriptions of specific embodiments of the present disclosure have been presented for purposes of illustration and description. They are not intended to be exhaustive or to limit the present disclosure to the precise forms disclosed, and obviously many modifications and variations are possible in light of the above teaching. The embodiments were chosen and described in order to best explain the principles of the present disclosure and its practical application, to thereby enable others skilled in the art to best utilize the present disclosure and various embodiments with various modifications as are suited to the particular use contemplated. It is understood that various omission and substitutions of equivalents are contemplated as circumstance may suggest or render expedient, but such are intended to cover the application or implementation without departing from the spirit or scope of the claims of the present disclosure.

### CLASSIFICATIONS

| | |
|---|---|
| U.S. Classification | 705/7.38, 705/7.39, 705/7.42, 705/319 |
| International | G06Q10/00 |
| Classification | |
| Cooperative Classification | G06Q10/10, G06Q10/06398, G06Q10/06393 |
| European Classification | G06Q10/10, G06Q10/06398, G06Q10/06393 |

### LITERARY REFERENCES

1. The Hayes Group International (2013). The Five Key Traits for Tomorrow's Strategic Leaders. http://www.thehayesgroupintl.com/2013/03/06/the-five-key-traits-for-tomorrows-strategic-leaders/-sthash.oaA2CyST.dpuf
2. Schawbel, Dan (2014). Douglas Stone: The importance of feedback in business communications. Forbes.com. http://www.forbes.com/sites/danschawbel/2014/03/05/douglas-stone-the-importance-offeedback-in-business-communications/
3. Ibid.
4. Ibid.
5. Flanagin, Andrew J. and Metzger, Miriam J. (2013). Trusting expert-versus user generated ratings online: The role of information volume, and consumer characteristics. Computers in Human Behavior 29: 1626-1634.
6. Ibid., 1628.

1. A system for evaluating leadership abilities and identifying leadership talent among users and organizations in a social network, the system comprising of:
a computer processor means for processing data;
a storage means for storing data on a storage medium;
a user account module configured to create a user profile;
a rater invite module configured to send requests for evaluations;
a user request module configured to allow users to send requests to evaluate another user;
an evaluation module to submit ratings of leadership abilities;
a computation module configured to compute leadership scores, assess leadership performance, and determine a category within which an individual falls to reflect the individual's evaluated leadership attributes and competencies.

2. The system of claim 1, wherein the user account module is configured to display the user's overall leadership score and ratings of leadership abilities to the user.

3. The system of claim 2, wherein the user account module is further configured to provide the user the option of displaying their overall leadership score and ratings of leadership skills to other users, selected individuals, and other social networks.

4. The system of claim 2, wherein the user account module is further configured to display both attributable and non-attributable comments by raters to the user.

5. The system of claim 2, wherein the user account module is further configured to provide the user the option of displaying both attributable and non-attributable comments by raters to other users, selected individuals, and other social networks.

6. The system of claim 1, wherein the evaluation module is further configured to invoke a leadership evaluation form upon a user accepting an invite to serve as a rater.

7. The system of claim 6, wherein the leadership evaluation form contains a list of leadership attributes and competencies and a rating scale.

8. The system of claim 6, wherein the evaluation module is further configured to submit completed evaluation forms to the computation module to capture ratings and compute an overall leadership score.

9. The system of claim 6, wherein the evaluation module is further configured to submit ratings such that they cannot be attributed to an individual.

10. The system of claim 6, wherein the evaluation module is further configured to receive optional attributable and non-attributable comments from raters.

11. The system of claim 1, wherein the computation module is configured to conduct analysis of captured ratings and user profiles to generate data and information.

12. The system of claim 11, wherein the computation module is further configured to update computations upon receipt of a completed evaluation form.

13. The system of claim 11, wherein the computation module is further modified to interface with the user account module to display ratings, overall leadership score, assessment of leadership performance, and additional analysis and information to the user.

14. The system of claim 1, wherein the system is a network-enabled system accessed using a desktop computer, laptop, or mobile device connected to the network.

15. A method for evaluating leadership abilities and identifying leadership talent among users and organizations of a social network, the method comprising of:
a user who is a member of a social or enterprise network that includes a plurality of other users;
sending invitations to other users to request evaluations that are based on their knowledge and observations of the user's leadership performance;
receiving initial and subsequent evaluations from a plurality of other users;
receiving either attributable or non-attributable comments from raters;
sending additional invitations and receiving subsequent evaluations from users;
computing an overall leadership score and scores of leadership attributes and competencies;
segmenting leadership scores into a hierarchy of zones or levels based on the number of ratings received and the overall leadership score;
updating the overall leadership score and scores of leadership attributes and competencies upon receipt of additional evaluations;
conducting data analysis and generating additional information based on user ratings and demographics;
displaying computed scores to the user with the option of sharing with other users or other social networks.

16. The method of claim 15, wherein users select performance descriptors that are converted to a rating scale and provide the means for evaluating a user's leadership attributes and competencies.

17. The method of claim 16, wherein a list of leadership attributes are provided that contain the means to describe and evaluate how a leader behaves and learns within an environment, how a leader is perceived, and the mental and social faculties the leader applies in the act of leading.

18. The method of claim 16, wherein a list of leadership competencies are provided that contain the means to describe and evaluate leadership skills and behaviors that contribute to exceptional performance, apply across all levels of leader positions and throughout careers, and provide a good basis for focused feedback.

19. The method of claim 15, wherein the leadership score is computed by averaging user generated ratings for leadership attributes and competencies.

20. The method of claim 15, wherein leadership scores are segmented by a coordinate system where the aggregate number of ratings defines the x-coordinate and the overall leadership score defines the y-coordinate.
